(19) United States
(12) Patent Application Publication
(10) Pub. No.: US 2013/0225387 A1
(43) Pub. Date: Aug. 29, 2013

(54) SEPARATION CONTAINER AND SEPARATION METHOD

(71) Applicants: Satoshi Hirai, Hiroshima-shi (JP); Noriko Takeda, Hiroshima-shi (JP); Osamu Okitsu, Okayama-shi (JP)

(72) Inventors: Satoshi Hirai, Hiroshima-shi (JP); Noriko Takeda, Hiroshima-shi (JP); Osamu Okitsu, Okayama-shi (JP)

(73) Assignee: JMS CO., LTD., Hiroshima-shi, Hiroshima (JP)

(21) Appl. No.: 13/882,654

(22) PCT Filed: Nov. 9, 2011
(86) PCT No.: PCT/JP2011/075858

§ 371 Date: Apr. 30, 2013

(30) Foreign Application Priority Data
Nov. 9, 2010 (JP) 2010-250699

(51) Int. Cl. B04B 7/08; B01D 21/26

(52) U.S. Cl. CPC B04B 7/08; B01D 21/262
USPC 494/37; 422/533

(57) ABSTRACT

The present invention provides a separation container capable of preventing contamination with unnecessary components and efficiently separating a separation subject. The separation container is a separation container for separating a separation subject from a sample, including: an outer container; an inner container; and a lid, wherein the outer container has a bottomed tubular shape with upper end thereof open and a lower end thereof closed, the inner container is tubular with an upper and lower ends thereof open, the inner container can be disposed inside the outer container with the up and down orientation of the inner container and the outer container aligned, and with the inner container disposed inside the outer container, a region below the disposed inner container inside the outer container is a storage portion for a precipitate in the sample, the lid is attachable over and detachable from an opening at the upper end of the inner container, and the inner container is made liquid-tight by attaching the lid over the opening of the inner container.

### TECHNICAL FIELD

The present invention relates to a separation container and a separation method.

### BACKGROUND ART

50% or more of infertility cases are attributed to defects in males. Examples of male infertility include: oligozoospermia, characterized by a low sperm concentration in semen; and asthenozoospermia, characterized by poor motility of sperms. In such cases, for example, an assisted reproductive technology using sperms collected from semen, such as artificial insemination, in vitro fertilization, or intracytoplasmic sperm injection is applied.

Examples of a method of preparing a sperm sample include: a separation method using density gradient centrifugation (density gradient centrifugation method) and a separation method utilizing the motility of sperms (swim-up method). In the former, first, Percoll is poured into a centrifuge tube, and semen then is layered on the Percoll, which then is subjected to centrifugation. Thus, a density gradient is formed, and sperms are separated in the lowermost layer. A pipette is then inserted from an upper portion of the centrifuge tube, and a fraction in the lowermost layer is collected. Thus, a sperm sample is obtained. In the latter, first, a semen is separated into an upper layer containing seminal plasma and a lower layer with high concentration of a solid by centrifugation. The lower layer contains sperms. Subsequently, the solid is caused to sink to the bottom of a container containing a medium. At that time, mature sperms with motility swim up in the medium to float to an upper portion of the medium from the bottom with linear motion. Therefore, mature sperms can be obtained through recovering the upper layer of the medium.

However, in the density gradient centrifugation method as the former method, a pipette is inserted from an upper portion of the centrifuge tube into a lower layer, so that components present in the vicinity of a middle layer of the Percoll might adhere to the pipette. This may cause a problem of the sperms being contaminated with these unnecessary components. In the vicinity of the middle layer, the seminal plasma or components of the testicular tissue are present, and also bacteria and viruses are present in some cases. Contamination by the seminal plasma and the like leads to dilution of the sperms in the sperm sample, which might affect the motility of the sperms. Moreover, contamination with bacteria and the like might affect the safety of a fertilized egg and the resulting fetus and also might affect the safety of operators who prepare sperms. For the same reason, they similarly might affect the swim-up method as the latter method. In order to solve this problem, the following sperm collecting tools have been proposed.

Patent Document 1 discloses a collecting tool obtained by disposing a collection tube in a centrifuge tube. The collection tube is disposed in the centrifuge tube with the tip of the collection tube reaching the bottom of the centrifuge tube. Then, Percoll and a semen were poured into the centrifuge tube, which then is subjected to centrifugation. After the centrifugation, a syringe is connected to the collection tube, and sperms that have settled down on the bottom of the centrifuge tube are collected by aspirating them into the syringe. However, since the tip of the collection tube is located at the bottom of the centrifuge tube, there is a risk that sperms might be damaged physically by the tip of the collection tube during centrifugation.

Patent Document 2 discloses a tool in which an inner space of the tool is divided into a sample supply chamber and a collection chamber for a subject to be separated (hereinafter simply referred to as a “separation subject”) along the axial direction by a partition. In the tool, the partition has a through hole that can allow the sample supply chamber and the collection chamber to communicate with each other in its lower portion. The density gradient centrifugation method using this tool is performed as follows. First, Percoll is supplied to each of the sample supply chamber and the collection chamber, and semen further is layered on the Percoll in the sample supply chamber. Then, sperms are caused to settle down to a lower portion of the sample supply chamber by centrifugation. At that time, since the sample supply chamber and the collection chamber are communicating with each other via the through hole in its lower portion, the sperms that have settled down move to the collection chamber via the through hole. Subsequently, a pipette is inserted into the collection chamber, and a Percoll solution is collected. Only sperms move to the collection chamber, so that a sperm sample containing no impurities can be obtained. However, since the inner space of this tool is divided into the sample supply chamber and the collection chamber along the axial direction in this tool, the sample supply chamber cannot ensure a sufficient volume, and it is difficult to insert a pipette into the collection chamber in some cases.

Patent Document 2 further discloses a tool in which an attachment as the sample supply chamber is disposed inside a container main body. When the attachment is disposed in the container main body, the inner space of the container main body is divided into the sample supply chamber and the collection chamber along the axial direction by a side wall of the attachment. That is, the inner space of the attachment is the sample supply chamber, and the remaining space of the container main body is the collection chamber. The side wall of the attachment has a through hole in its lower portion. In the case of using this tool, when sperms are settled down inside the sample supply chamber by centrifugation, the sperms move from the sample supply chamber to the collection chamber via the through hole. Therefore, when the attachment is taken out from the container main body after centrifugation while maintaining liquid tightness of the attachment, only Percoll containing the sperms is present inside the container main body. Thus, by merely taking the attachment out from the container main body, a sperm sample containing no impurities can be obtained. However, a large amount of Percoll is also supplied to the collection chamber before centrifugation. Therefore, there is a problem in that the concentration of sperms remaining in the container main body is low. Moreover, Percoll is relatively expensive, and therefore the cost thereof is also a problem.

Such problems occur not only in preparation of a sperm sample, but also in the fields involving separation of a separation subject from a sample by centrifugation.

### PRIOR ART DOCUMENTS

### Patent Document

Patent Document 1: JP 2004-313500 A
Patent Document 2: JP 2009-119457 A

### SUMMARY OF INVENTION

With the foregoing in mind, it is an object of the present invention to provide a separation container capable of preventing contamination with unnecessary components and efficiently separating a separation subject.

In order to achieve the above object, a separation container according to the present invention is a separation container for separating a separation subject from a sample, the separation container including: an outer container; an inner container; and a lid, wherein the outer container has a bottomed tubular shape with an upper end thereof open and a lower end thereof closed, the inner container is tubular with upper and lower ends thereof open, the inner container can be disposed inside the outer container with the up and down orientation of the inner container and the outer container aligned, and with the inner container disposed inside the outer container, a region below the disposed inner container inside the outer container is a storage portion for a precipitate in the sample, the lid is attachable over and detachable from an opening at the upper end of the inner container, and the inner container is made liquid-tight by attaching the lid over the opening of the inner container.

A separation method according to the present invention is a method of separating a separation subject from a sample, using the separation container according to the present invention, the method including the steps of: (A1) disposing an inner container inside an outer container and adding a centrifugal treatment solution to the inner container and a storage portion of the outer container; (B1) supplying a sample to the inner container after the step (A1); (C1) subjecting the separation container to centrifugation after the step (B1), whereby a precipitate in the sample is led to the storage portion of the outer container; and (D1) taking the inner container out from the outer container after the step (C1) with the lid attached over the inner container.

According to the separation container of the present invention, a separation subject settled by centrifugation can be led from the inner container to the storage portion of the outer container through a tip port at the lower end of the inner container, for example. Then, the inner container is made liquid-tight by attaching the lid thereover. Therefore, the separation subject can be recovered in the outer container by merely taking the inner container out from the outer container. Moreover, according to the separation container of the present invention, the storage portion can be designed in any size. Therefore, it is possible to set the fluid amount that remains inside the outer container after taking the inner container out from the outer container to any amount, for example, a small amount, by downsizing the storage portion. When the fluid amount is relatively small, a sample with high concentration of the separation subject can be obtained. Moreover, when the concentration of the separation subject is high, the amount of a centrifugal treatment solution to be used can be small. Therefore, for example, in the case where Percoll is used, the cost thereof can be low.

### BRIEF DESCRIPTION OF DRAWINGS

FIGS. 1A to 1C are cross-sectional views each showing an example of a component of a separation container according to the present invention. FIG. 1A is a cross-sectional view of an outer container. FIG. 1B is a cross-sectional view of an inner container. FIG. 1C is a cross-sectional view of a lid.

FIG. 2 is a cross-sectional view showing an example of the separation container according to the present invention.

FIGS. 3A to 3C are cross-sectional views each showing an example of a component of a separation container according to the present invention. FIG. 3A is a cross-sectional view of an outer container. FIG. 3B is a cross-sectional view of an inner container.

FIG. 3C is a cross-sectional view of a lid.

FIG. 4 is a cross-sectional view showing an example of the separation container according to the present invention.

FIGS. 5A to 5C are cross-sectional views each showing an example of a separation container according to the present invention.

FIGS. 6A to 6C are schematic views showing an example of an outer container in the present invention. FIG. 6A is a cross-sectional view. FIG. 6B is a top plan view. FIG. 6C is a top perspective view.

FIGS. 7A and 7B are schematic views showing an example of an inner container in the present invention. FIG. 7A is a cross-sectional view. FIG. 7B is a top perspective view.

FIGS. 8A and 8B are schematic views each showing an example of a separation container according to the present invention. FIGS. 8A and 8B are cross-sectional views each showing the state where a projection of the inner container is being inserted into a different groove of an outer container.

FIGS. 9A and 9B are schematic views each showing an example of a component in the present invention. FIG. 9A is a perspective view showing an upper portion of an outer container. FIG. 9B is a perspective view showing an upper portion of an inner container.

FIG. 10 is a perspective view showing an example of an outer container in the present invention.

FIGS. 11A and 11B are schematic views showing an example of an outer container in the present invention. FIG. 11A is a cross-sectional view in the axial direction. FIG. 11B is a cross-sectional view taken along the line I-I of FIG. 11A.

FIGS. 12A and 12B are schematic views showing an example of an inner container in the present invention. FIG. 12A is a cross-sectional view in the axial direction. FIG. 12B is a cross-sectional view taken along the line II-II of FIG. 12A.

FIG. 13 is a cross-sectional view showing an example of a separation container according to the present invention.

FIGS. 14A and 14B are schematic views each showing an example of a component in the present invention. FIG. 14A is a cross-sectional view of an outer container. FIG. 14B is a cross-sectional view of an inner container.

FIGS. 15A and 15B are schematic views showing an example of an outer container in the present invention. FIG. 15A is a top plan view of a tip portion of the outer container. FIG. 15B is a cross-sectional view of the outer container.

FIGS. 16A and 16B are schematic views showing an example of a separation container according to the present invention.

FIG. 16A is a cross-sectional view in the axial direction. FIG. 16B is a cross-sectional view taken along the line of FIG. 16A.

FIGS. 17A and 17B are schematic views each showing an example of a separation container according to the present invention. FIG. 17A is a cross-sectional view of a separation container including an inner container which has projections. FIG. 17B is a cross-sectional view of a separation container including an outer container which has projections.

FIGS. 18A and 18B are schematic views showing an example of a separation container according to the present invention.

FIG. 18A is a perspective view showing the tip of an inner container provided with a rib. FIG. 18B is a cross-sectional view of the separation container including the inner container of FIG. 18A.

FIGS. 19A and 19B are schematic views each showing an example of a separation container according to the present invention. FIG. 19A is a cross-sectional view of a separation container including an oval inner container. FIG. 19B is a cross-sectional view of a separation container including an inner container disposed on one side.

FIG. 20 is a graph showing the average concentration rate of recovered living sperms in Example 2 of the present invention.

### DESCRIPTION OF EMBODIMENTS

### Separation Container

The separation container according to the present invention is, as mentioned above, a separation container for separating a separation subject from a sample, the separation container including: an outer container; an inner container; and a lid, wherein the outer container has a bottomed tubular shape shape with an upper end thereof open and a lower end thereof closed, the inner container is tubular with upper and lower ends thereof open, the inner container can be disposed inside the outer container with the up and down orientation of the inner container and the outer container aligned, and with the inner container disposed inside the outer container, a region below the disposed inner container inside the outer container is a storage portion for a precipitate in the sample, the lid is attachable over and detachable from an opening at the upper end of the inner container, and the inner container is made liquid-tight by attaching the lid over the opening of the inner container.

The outer container and the inner container are tubular, particularly preferably cylindrical.

In the separation container according to the present invention, it is preferred that with the inner container disposed inside the outer container, at least one of an end face of a tip port and an outer peripheral surface of a tip at a lower end of the inner container is in contact with an inner peripheral surface of the outer container. By bringing the outer container into contact with a lower portion of the inner container as described above, a physical load on the inner container during centrifugation can be reduced, for example.

Either one or both of the end face of the tip port and the outer peripheral surface of the tip at the lower end of the inner container may be in contact with the inner peripheral surface of the outer container.

The following effects can be obtained by bringing the lower end of the inner container into contact with the inner peripheral surface of the outer container as described above, for example. That is, the separation container according to the present invention is suitable also for separation of sperms by the swim-up method, for example. In the swim-up method, sperms are disposed in the storage portion of the outer container, and a liquid in which sperms can swim is then supplied to the inner container, for example. Healthy sperms with motility swim up from the storage portion to the inner container through an opening at the lower end thereof with linear motion. As mentioned above, the lower end of the inner container is in contact with the inner peripheral surface of the outer container in the separation container according to the present invention. Therefore, the sperms that have swum up from the storage portion are efficiently guided into the inner container through the opening. Thus, the sperms with motility can be recovered with superior recovery rate.

The whole or a partial region of the end face of the tip port at the lower end of the inner container may be in contact with the inner peripheral surface of the outer container, for example. In the latter case, for example, the number of points to be in contact with the outer container may be one or more, for example.

The whole of the outer peripheral surface of the tip or a partial region of the end face at the lower end of the inner container may be in contact with the inner peripheral surface of the outer container, for example. In the latter case, for example, the number of points to be in contact with the outer container may be one or more.

The outer peripheral surface of the tip of the inner container may have a projection, for example. In this case, the projection at the lower end of the inner container may be in contact with the inner peripheral surface of the outer container. The projection of the inner container is not particularly limited, and the number of the projections may be, for example, one or more.

The inner peripheral surface in an upper end portion of the storage portion of the outer container may have a projection, for example. In this case, the projection of the outer container may be in contact with at least one of the end face of the tip port and the outer peripheral surface of the tip at the lower end of the inner container, for example. The projection of the outer container is not particularly limited, and the number of the projections is, for example, one or more.

The inner peripheral surface in an upper end portion of the storage portion of the outer container may have a circumferential projection, for example. Specifically, for example, a side wall forming the storage portion is a circumferential projection, and a circumferential groove may be formed on the outer peripheral surface of the storage portion, for example. In this case, the end face of the tip port at the lower end of the inner container may be in contact with the projection, specifically the inner surface of the projection. In the present invention, in the case where the inner peripheral surface of the outer container has the projection, it includes the surface of the projection, for example.

The outer container and the inner container may have a concave portion (e.g., a groove) and a convex portion (e.g., a projection) capable of engaging with each other at the respective positions corresponding to each other when the inner container is disposed in the outer container, for example. By providing the outer container and the inner container with the concave portion and the convex portion, the inner container can be attached to the outer container more stably, for example. Moreover, for example, those who handle the separation container can recognize the engagement between the concave portion and the convex portion by the sense of touch with their hands and fingers when the inner container is disposed in the outer container. Thus, the separation container can be handled more easily.

The lower end of the inner container is in contact with the inner peripheral surface of the outer container as mentioned above. The lower end of the inner container may partially be in contact with the inner peripheral surface of the outer container. By the contact, a space may or may not be present between the outer peripheral surface of the inner container and the inner peripheral surface of the outer container at the boundary between the lower end of the inner container and the upper end of the storage portion of the outer container, for example. The latter is preferable. In the former case, the space preferably is a space through which sperms cannot pass, for example. With this space, it is possible to efficiently lead sperms inside the inner container when the sperms swim up from the storage portion of the outer container, for example. The space through which sperms cannot pass is not particularly limited. In the space, for example, the distance between the outer peripheral surface at the lower end of the inner container and the inner peripheral surface of the outer container facing the outer peripheral surface preferably is 200 μm or less, more preferably 100 μm or less, yet more preferably 50 μm or less in the direction perpendicular to the axis.

The outer peripheral surface of the inner container may include a tapered portion. The tapered portion may entirely or partially be in contact with the inner peripheral surface of the outer container, for example. The inner peripheral surface of the inner container, corresponding to the tapered portion may be tapered as in the outer peripheral surface, for example. The position of the tapered portion in the inner container is not particularly limited and can be, for example, the lower side and may be the lower end. The tapered portion of the inner container may include a cylindrical tip portion on the lower side thereof, for example.

The inner peripheral surface of the outer container may have a tapered portion. The position of the tapered portion in the outer container is not particularly limited and can be, for example, the upper side of the storage portion. The tapered portion may be connected to an upper end portion of the storage portion. In this case, the tapered outer peripheral surface of the inner container may entirely or partially be in contact with the tapered inner peripheral surface of the outer container with the inner container disposed inside the outer container, for example. The outer peripheral surface of the outer container, corresponding to the tapered portion may be tapered as in the inner peripheral surface, for example.

The outer peripheral surface at the upper end of the inner container further may have a circumferential projection, for example. It is preferred that the projection is not inserted into the outer container and is exposed to the opening of the outer container, for example. The projection is, for example, a grip portion of the inner container. It is preferred that a space between the outer container and the inner container can be closed at the upper end by the projection, for example.

The lid can close the opening by being attached over the opening at the upper end of the inner container. It is preferred that the lid also closes the opening at the upper end of the outer container by being attached over the inner container disposed inside the outer container, for example. The lid may be in the form of being connected to the inner container or the form of being attached over the inner container as a member which is different from the inner container when used, for example. The lid may be in the form of being connected to the outer container, for example. The way of attaching the lid is not particularly limited and may be achieved by allowing the lid to be screwed in, to mesh with, to be fitted in, or to be in pressure contact with the member on which it is to be attached, for example.

For example, it is preferred that either one of the inner peripheral surface of the outer container and the outer peripheral surface of the inner container has a projection (convex portion), and the other has a groove (concave portion) capable of engaging with the projection. For example, it is preferred that the inner container can be locked inside the outer container by the projection and the groove. The projection is referred to as a projection for engagement, and the groove is referred to as a groove for engagement, for example. Any of the outer container and the inner container may have the projection or the groove, for example. The projection and the groove are disposed so as to be engaged with each other when the inner container is disposed inside the outer container, for example. As a specific example, it is possible that the inner peripheral surface of the outer container has the groove, and the outer peripheral surface of the inner container has the projection, and it is also possible that the inner peripheral surface of the outer container has the projection, and the outer peripheral surface of the inner container has the groove. The shapes of the projection and the groove, the number of the projections, and the number of the grooves are not particularly limited.

It is preferred that the groove and the projection are provided so as to extend along the axial direction, for example. It is preferred that the inner container and the outer container are engaged with each other by inserting the projection provided so as to extend along the axial direction into the groove provided so as to extend along the axial direction when the inner container is inserted into the outer container from the opening on the upper side thereof. The outer container may have a plurality of grooves with different depths, for example. In this case, it is preferred that the inner container has a projection with a length with which the projection can be inserted into the deepest groove. As mentioned above, in the case where the outer container has a plurality of grooves with different depths, the depth to which the inner container is inserted into the outer container, i.e., a position of the inner container inside the outer container along the axial direction can be adjusted according to which groove the projection is inserted into. It is to be noted that, as mentioned above, it is possible that the outer container has the projection, and the inner container has the groove.

It is preferred that the outside of the storage portion of the outer container has a concentric groove, for example, and the outside of the tip of the inner container has a concentric projection, for example. Furthermore, it is preferred that the projection of the inner container can be inserted into the groove of the outer container when the inner container is disposed inside the outer container. It is preferred that the groove of the outer container is formed of the outer wall of the storage portion and the outer wall of the outer container. Even when a liquid which has adhered to the upper portion of the outer container runs down the inner wall of the outer container, the liquid can be led to the groove in the outer container, and contamination of the storage portion with the liquid can be prevented, by providing the outside of the storage portion with the groove as described above, for example. Thus, for example, the fluid amount in the storage portion can be sufficiently prevented from increasing when the inner container is taken out from the outer container.

The material for forming the separation container is not particularly limited. Examples thereof include synthetic resin materials, metallic materials, and glass materials. Among these, for example, the synthetic resin materials are preferable from the viewpoint of workability such as formability, assemblability, and if necessary, adhesiveness and the like, hygiene such as elution of an additive to a sample and the like, functionality such as visibility and the like, cost, and the like. Examples of the material include synthetic resins such as fluorine resins, polypropylene, polyethylene, polycarbonate, polyester, polyurethane, polymethylpentene, methacryl, ABS (acrylonitolyl butadiene styrene copolymer), PET (polyethylene terephthalate), polyvinyl chloride, silicone, ethylene vinyl acetate copolymer, synthetic rubbers, and various elastomers. Among these, fluorine resins, polypropylene, polyethylene, and polycarbonate are preferable. Among the fluorine resins, for example, hydrophobic fluorine resins are preferable, and polytetrafluoroethylene (PTFE) is particularly preferable.

The use of the separation container according to the present invention is not particularly limited. The separation container according to the present invention preferably is used for separation of sperms from a sample, for example. In the case where the separation container according to the present invention is used for separation of sperms from a sample, the separation method is not particularly limited, and the separation container can be used in the density gradient centrifugation method, the swim-up method, or the like, for example. When the separation container according to the present invention is used in the density gradient centrifugation method, it can be used not only for separation of sperms, but also for separation of cell organelles, separation of DNA or RNA, separation of a specific component in blood (e.g., erythrocyte, monocyte, or plasma), and the like, for example. The sample is not particularly limited and can be a sample containing the separation subject. Specific examples of the sample include a semen, blood, and the like.

Separation Method

The separation method according to the present invention is a method of separating a separation subject from a sample, using the separation container according to the present invention, the method including the steps of: (A1) disposing an inner container inside an outer container and adding a centrifugal treatment solution to the inner container and a storage portion of the outer container; (B1) supplying a sample to the inner container after the step (A1); (C1) subjecting the separation container to centrifugation after the step (B1), whereby a precipitate in the sample is led to the storage portion of the outer container; and (D1) taking the inner container out from the outer container after the step (C1) with the lid attached over the inner container.

The centrifugal treatment solution is not particularly limited and can be decided as appropriate according to the kinds of the sample and the separation subject, for example. Examples thereof include density gradient carriers, media, and buffer solutions. The density gradient carrier can also be referred to as a specific gravity adjusting agent, for example. The density gradient carrier is not particularly limited, and examples thereof include Percoll, modified colloid silica, sucrose polymers, and Ficoll. Percoll generally is in the form of colloidal silica sol having a polyvinyl pyrrolidone coating. As the Percoll, for example, it is preferred to use Percoll from which endotoxin is removed and then isotonized by adding a medium. The concentration of Percoll is not particularly limited, and preferably is 90% to 98%, for example. When the separation subject is sperms, the medium is, for example, a liquid containing HEPES.

In the step (A1), the order of disposing an inner container inside an outer container and adding a centrifugal treatment solution is not limited. The step (A1) may be, for example, either one of the following steps of:

(A1-1) disposing an inner container inside an outer container and thereafter supplying a centrifugal treatment solution to the inner container, whereby the centrifugal treatment solution is added to the inner container and a storage portion of the outer container; and (A1-2) supplying a centrifugal treatment solution to an outer container and thereafter disposing the inner container inside an outer container, whereby the centrifugal treatment solution is added to the inner container and a storage portion of the outer container.

In the step (A1-1), an inner container is disposed inside an outer container, and thereafter a centrifugal treatment solution is poured into the inner container, for example. Thus, for example, the centrifugal treatment solution also can be added to a storage portion of the outer container through an opening at the lower end of the inner container. In the step (A1-2), a centrifugal treatment solution is poured into an outer container, and thereafter an inner container is disposed inside the outer container, for example. Thus, for example, the centrifugal treatment solution also can be added to the inner container. In this case, the centrifugal treatment solution is supplied to the inner container through the opening at the lower end of the inner container.

In the step (B1), the method of supplying the sample is not particularly limited. In the case where the centrifugal treatment solution is a density gradient carrier, it is preferred that the sample is layered on the density gradient carrier, for example.

In the step (C1), the conditions of the centrifugation are not particularly limited and can be decided as appropriate according to the kinds of the sample and the separation subject, for example. As a specific example, the conditions are, for example, at 1000G (1000×9.80665 m/s²) for 20 to 30 minutes. It is preferred that the centrifugation is performed with the lid attached over the inner container, for example. By the centrifugation, a precipitate in the sample is discharged to the storage portion of the outer container through the opening at the lower end of the inner container.

In the step (D1), the inner container is made liquid-tight by attaching the lid over the inner container. Therefore, the inner container can be taken out from the outer container without leaking a liquid inside the inner container out from the opening at the lower end. The precipitate in the sample is led to the storage portion of the outer container. Thus, the separation subject which has settled can be recovered through recovering the liquid in the storage portion.

The separation subject is not particularly limited as mentioned above. The separation method according to the present invention preferably is applied to separation of sperms. When sperms are separated, the separation container according to the present invention can be applied in a centrifugation method or a swim-up method, for example.

The first form of the separation method according to the present invention can be, for example, a centrifugation method, i.e., a method in which sperms are settled by centrifugation and recovered. In this case, the following are preferable, for example. In the step (B1), a sample containing sperms such as a semen or the like is supplied to the inner container. Then, in the step (C1), the separation container is subjected to centrifugation, whereby sperms being in the sample are settled and led to the storage portion of the outer container. Subsequently, in the step (D1), the inner container is taken out from the outer container. Then, sperms being in the storage portion of the outer container are recovered.

The first form is, for example, preferably a density gradient method using the density gradient carrier as the centrifugal treatment solution, for example.

The first form can be used in combination with the swim-up method. In this case, the following are preferable, for example. In the step (C1), the separation container is subjected to centrifugation, whereby sperms in the sample are settled and led to the storage portion of the outer container. In the step (D1), the inner container is taken out from the outer container. Then, the first form preferably further includes the following steps of: (E1) after the step (D1), disposing another inner container in the outer container and adding a liquid in which sperms can swim to the another inner container before or after the disposition; and (F1) after the step (E1), recovering the sperms that have swum up from the storage portion of the outer container to the another inner container.

The centrifugal treatment solution containing the sperms that have been settled down is present in the storage portion of the outer container after taking the inner container out from the outer container in the step (D1). Then, in the step (E1), another inner container is disposed in the outer container, and the liquid is added to the inner container. Therefore, sperms superior in motility swim up from the storage portion of the outer container to the another inner container through the opening of the inner container. Thus, the sperms superior in motility can be recovered by recovering the liquid inside the another inner container. In the step (E1), addition of the liquid to the another inner container is not particularly limited. For example, the liquid may be added to the another inner container after disposing the another inner container in the outer container, or the another inner container to which the liquid has been previously added may be disposed in the outer container while maintaining the liquid-tight state.

In the step (F1), for example, the sperms being in the another inner container may be recovered by taking the another inner container out from the outer container with the lid attached over the another inner container. In this case, the liquid in the another inner container may move to another container such as a test tube through taking the another inner container out from the outer container, then, for example, inserting the lower end of the another inner container into the another container, and releasing the another inner container from the liquid-tight state. In the step (F1), the liquid containing sperms may be recovered from the another inner container with a pipette or the like, for example.

The liquid in which sperms can swim is not particularly limited and can be, for example, the medium. As a specific example, the medium can be, for example, a liquid containing HEPES.

The second form of the separation method according to the present invention can be, for example, a swim-up method. In this case, it is preferred that the separation container according to the present invention is used in the separation method, and the separation method includes the steps of:

(A2) supplying a sample containing sperms to a storage portion of an outer container;
(B2) after the step (A2), disposing an inner container inside the outer container and adding a liquid in which a sperm can swim to the inner container before or after the disposition; and
(C2) after the step (B2), recovering the sperm that has swum up from the storage portion of the outer container to the inner container.

In the step (C2), it is preferred that the sperms being in the inner container are recovered by taking the inner container out from the outer container with the lid attached over the inner container.

The separation container and the separation method using the same according to the present invention are described below with reference to the following embodiments. The separation container and the separation method according to the present invention, however, are not limited to these embodiments. Hereinafter, the description is made with reference to the figures. In the figures, identical parts are denoted by the identical reference numerals unless otherwise shown. Each embodiment can be described with reference to the other embodiments unless otherwise shown.

### Embodiment 1

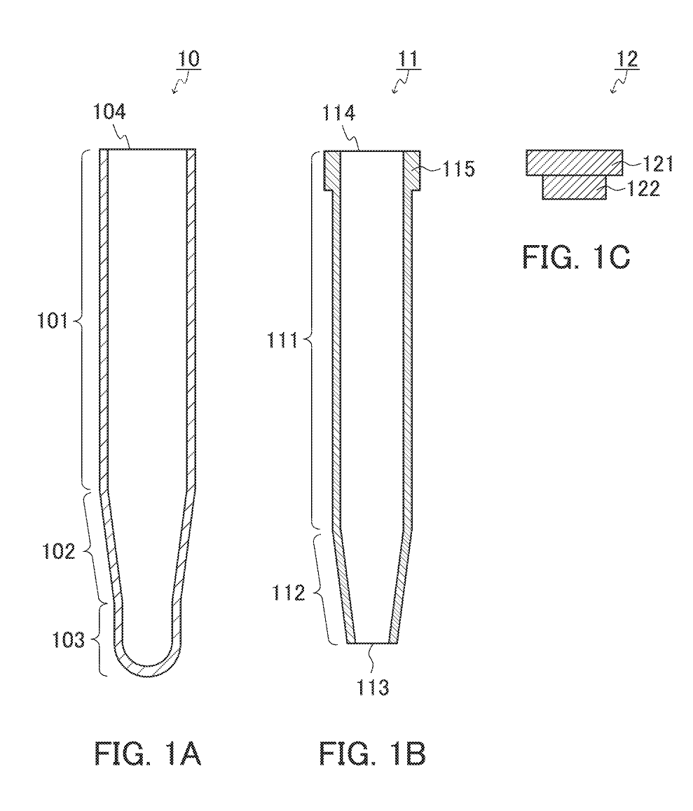

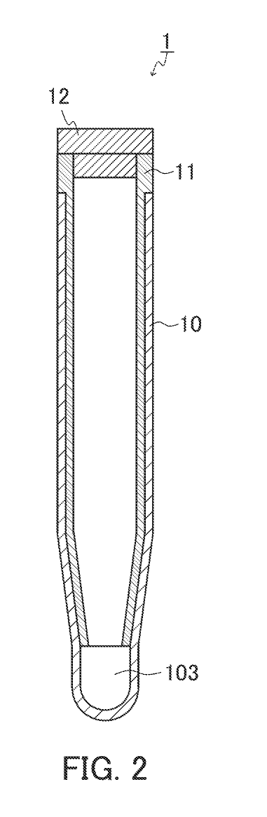

FIGS. 1A to 1C and 2 show a separation container according to the present embodiment. FIGS. 1A to 1C are cross-sectional views of the respective components configuring the separation container.

FIG. 1A shows an outer container, FIG. 1B shows an inner container, and FIG. 1C shows a lid. FIG. 2 is a cross-sectional view of the separation container.

As shown in FIG. 1A, the outer container 10 has a bottomed tubular shape shape having an opening 104 at the upper end thereof and includes: a main body portion 101; a tapered portion 102; and a storage portion 103. As shown in FIG. 1B, the inner container 11 has an opening 114 at the upper end thereof (hereinafter also referred to as an “upper opening 114”) and an opening 113 at the lower end thereof (hereinafter also referred to as a “lower opening 113”) and includes: a main body portion 111; and a tapered portion 112. The outer peripheral surface in an upper portion of the main body portion 111 has a circumferential projection 115. The projection 115 is, for example, a grip portion of the inner container 11 as mentioned above. As shown in FIG. 1C, for the projection at the upper end, a lid 12 includes: a grip portion 121; and an insertion portion 122, for example.

The sizes of the outer container 10, the inner container 11, and the lid 12 are not particularly limited as long as they satisfy the following conditions, for example. The inner container 11 can be disposed inside the outer container 10. The inner peripheral surface of the outer container 10 is in contact with at least one of the end face of the opening 113 at the lower end of the inner container 11 and the outer peripheral surface of the opening 113. The lid 12 is attachable over the opening 114 at the upper end of the inner container 11. The inner container 11 is made liquid-tight by attaching the lid 12 over the inner container 11.

The sizes of the respective components can be decided as appropriate according to the kinds of the sample and the separation subject, the amount of the sample, and the like, for example. In the present invention, the “axial direction” indicates the longitudinal direction of the separation container, the inner container, or the outer container. The “perpendicular direction” indicates a direction perpendicular to the axial direction. The “height” indicates the length in the axial direction. The “diameter” indicates a diameter of the cross sectional surface in the perpendicular direction.

The size of the outer container 10 is not particularly limited and examples thereof include the following conditions. The total volume is, for example, from 0.5 to 100 ml, preferably from 1.0 to 50 ml. The inner height of the entire outer container 10 is, for example, from 30 to 200 mm, preferably from 50 to 120 mm. The height of the main body portion 101 is, for example, from 80 to 120 mm, preferably from 105 to 115 mm. The height of the tapered portion 102 is, for example, from 5 to 20 mm, preferably from 10 to 15 mm. The height of the storage portion 103 is, for example, from 5 to 15 mm, preferably from 8 to 12 mm. The inner diameter of the opening 104 is, for example, from 10 to 20 mm, preferably from 13 to 15 mm. The inner diameter at the upper end of the tapered portion 102 is, for example, from 8 to 18 mm, preferably from 10 to 13 mm. The inner diameter at the upper end of the storage portion 103 is, for example, from 5 to 15 mm, preferably from 6 to 7 mm. The volume of the storage portion 103 is, for example, from 0.1 to 0.5 ml, preferably from 0.2 to 0.4 ml. The inner height of the storage portion 103 is, for example, from 4 to 10 mm, preferably from 5 to 8 mm.

The size of the inner container 11 is not particularly limited, and examples thereof include the following conditions. The total volume is, for example, from 0.3 to 100 ml, preferably from 0.5 to 50 ml. The height of the entire inner container 11 is, for example, from 60 to 100 mm, preferably from 80 to 90 mm. The height of the main body portion 111 is, for example, from 50 to 90 mm, preferably from 60 to 70 mm. The height of the tapered portion 112 is, for example, from 5 to 30 mm, preferably from 10 to 20 mm. The inner diameter of the upper opening 114 is, for example, from 5 to 20 mm, preferably from 10 to 14 mm. The outer diameter of the upper opening 114, i.e., the outer diameter of the projection 115 is, for example, from 10 to 20 mm, preferably from 14 to 18 mm. The outer diameter at the upper end of the tapered portion 112 is, for example, from 8 to 18 mm, preferably from 10 to 15 mm. The outer diameter at the lower end of the tapered portion 112, i.e., the outer diameter of the lower opening 113 is, for example, from 3 to 8 mm, preferably from 4 to 7 mm. The inner diameter of the lower opening 113 is, for example, from 2 to 7 mm, preferably from 3 to 6 mm.

The size of the lid 12 is not particularly limited, and examples thereof include the following conditions. The outer diameter of the grip portion 121 is, for example, from 10 to 20 mm, preferably from 12 to 18 mm. The outer diameter of the insertion portion 122 is, for example, from 5 to 20 mm, preferably from 10 to 14 mm. The height of the insertion portion 122 is, for example, from 2 to 10 mm, preferably from 4 to 6 mm.

Next, a method of separating sperms by centrifugation, using the separation container according to the present embodiment is described with reference to FIGS. 1A to 1C and 2.

First, an inner container 11 is disposed inside an outer container 10. At that time, the outer peripheral surface at the lower end of the inner container 11 is in contact with the inner peripheral surface of the outer container 10. Specifically, as shown in FIG. 2, the outer peripheral surface of a tapered portion 112 of the inner container 11 is in contact with the inner peripheral surface of a tapered portion 102 of the outer container 10. In the present embodiment, it is only necessary that the outer peripheral surface at the lower end of the inner container 11 is in contact with the inner peripheral surface of the outer container 10. Thus, for example, the entire outer peripheral surface of the inner container 11 may not be in contact with the inner peripheral surface of the outer container 10.

Then, a centrifugal treatment solution is poured into the inner container 11. The inner container 11 has an opening 113 at the lower end thereof. Therefore, the centrifugal treatment solution that has been poured into the inner container 11 is led to a storage portion 103 of the outer container 10 through the opening 113. The amount of the centrifugal treatment solution is not particularly limited and can be decided as appropriate according to the sizes of the outer container 10 and the inner container 11. The amount is, for example, from 1 to 10 ml, preferably from 2 to 5 ml.

Subsequently, a sample containing sperms is supplied to the inner container 11. It is preferred that the sample is layered on the centrifugal treatment solution inside the inner container 11.

Then, a insertion portion 122 of the lid 12 is inserted into the opening 114 of the inner container 11, so that the inner container 11 is made liquid-tight. Thereafter, the separation container 1 is subjected to centrifugation. The conditions of the centrifugation are not particularly limited and are, for example, at 1000G (1000×9.80665 m/s²) for 20 to 30 minutes. By the centrifugation, sperms are separated from the sample and settled down from the opening 113 of the inner container 11 to the storage portion 103 of the outer container 10. According to the present embodiment, even during centrifugation, the separation container is superior in physical stability.

After the centrifugation, the inner container 11 is taken out from the outer container 10 with the lid 12 attached over the inner container 11. The inner container 11 contains unnecessary substances of the sample. However, since the inner container 11 is in the liquid-tight state while the lid 12 is attached thereover, the inner container 11 can be taken out from the outer container 10 without leaking a liquid out from the inner container 11. Thus, the centrifugal treatment solution containing sperms is recovered in the storage portion 103 of the outer container 10. The centrifugal treatment solution recovered in the storage portion 103 can be used as a sample containing recovered sperms.

In the present embodiment, the swim-up method can be further performed. First, the inner container 11 is taken out from the outer container 10, and then another inner container 11 is disposed in the outer container 10. It is preferred that a liquid in which sperms can swim is previously added to the another inner container 11. In this case, the liquid-tight state can be maintained by inserting the lid 12 into an opening 114 of the another inner container 11. Thus the another inner container 11 can be disposed in the outer container 10 without leaking the liquid out from the opening 113. Then, the separation container is allowed to stand in this state. Thus, sperms with motility swim up from the storage portion 103 of the outer container 10 to the another inner container 11 through the opening 113 of the another inner container 11. At that time, there is no space between the outer peripheral surface of the opening 113 of the another inner container 11 and the inner peripheral surface of the outer container 10 in the separation container 1. Thus, the sperms that have swum up can efficiently swim up to the another inner container 11.

As described above, only the sperms with motility move to the another inner container 11. Thus, only sperms with motility can be recovered by letting the separation container stand, then attaching the lid 12 over the another inner container 11, and taking the another inner container 11 out from the outer container 10 while maintaining liquid tightness of the another inner container 11. The sperms inside the another inner container 11 that are taken out may be recovered in another container by discharging a liquid from the another inner container 11 by detaching the lid 12 from the another inner container 11 so as to release liquid tightness of the another inner container 11, for example.

In centrifugation, a separation container generally is set in a centrifuge rotor. At that time, if there is a space between the set separation container according to the present embodiment and the centrifuge rotor, an adjuster may be attached to the separation container.

### Embodiment 2

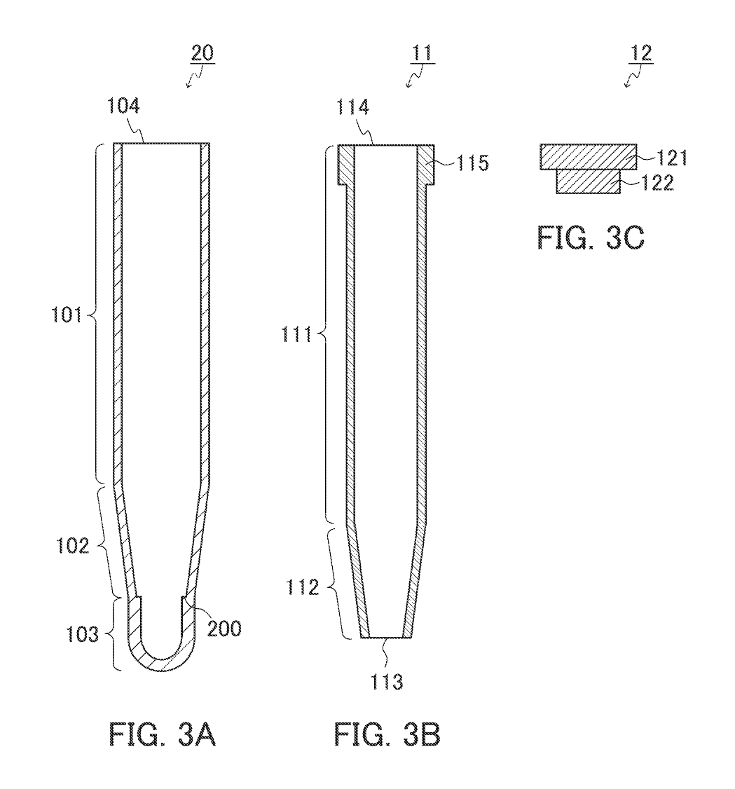

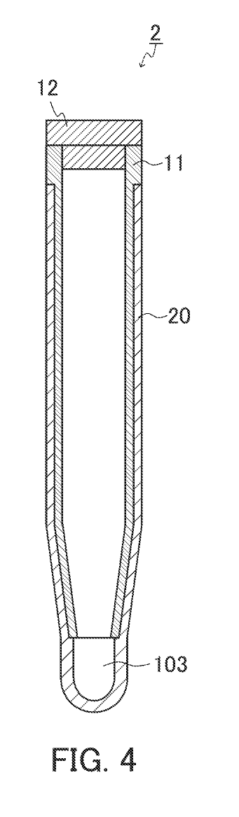

FIGS. 3A to 3C and 4 show a separation container according to the present embodiment. FIGS. 3A to 3C are cross-sectional views of the respective components configuring the separation container. FIG. 3A shows an outer container, FIG. 3B shows an inner container, and FIG. 3C shows a lid. FIG. 4 is a cross-sectional view of the separation container.

As shown in FIG. 3A, an outer container 20 has a bottomed tubular shape having an opening 104 at the upper end thereof and includes: a main body portion 101; a tapered portion 102; and a storage portion 103. The inner peripheral surface at the upper end of the storage portion 103 of the outer container 20 has a circumferential projection 200. The size of the projection 200 is not particularly limited. FIGS. 3B and 3C are the same as FIGS. 1B and 1C described above, respectively. As shown in FIG. 4, in the separation container 2, the inner container 11 is disposed inside the outer container 20, and a lid 12 is attached over the opening in the upper portion of the inner container 11.

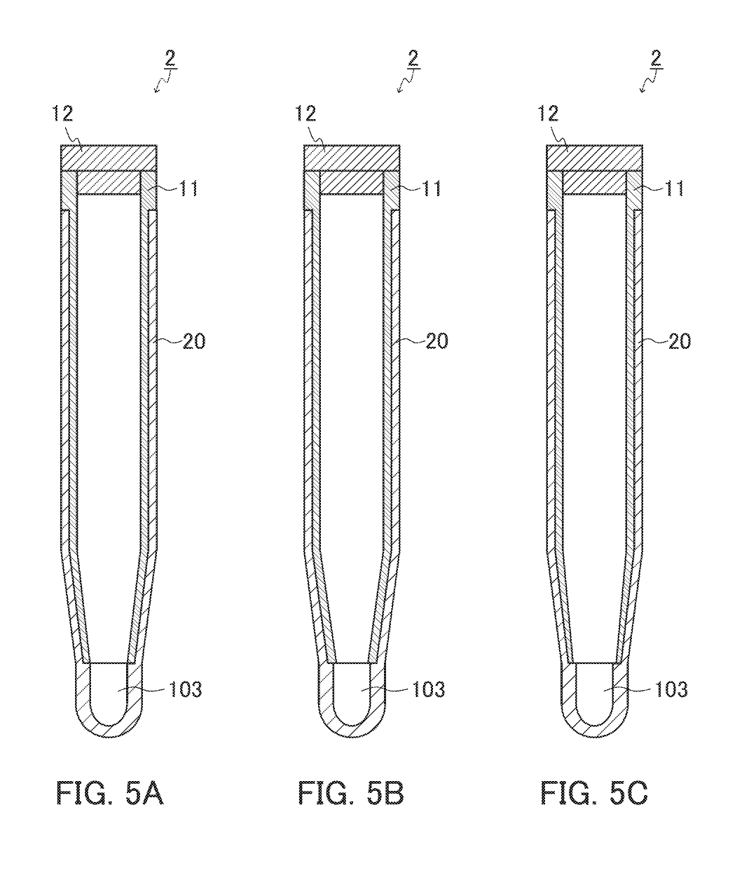

The projection 200 of the outer container 20 and a lower opening 113 of the inner container 11 can be in the following forms shown by the inner diameters, for example. The first form is, for example, a form in which the inner diameter of the projection 200 is almost identical to that of the opening 113 of the inner container 11. FIG. 5A shows an example of this form. FIG. 5A is a cross-sectional view of the separation container 2 with the inner container 11 disposed inside the outer container 20. As shown in FIG. 5A, the inner diameter of the projection 200 is almost identical to that of the opening 113 of the inner container 11. The second form is, for example, a form in which the inner diameter of the projection 200 is greater than that of the opening 113 of the inner container 11. FIG. 5B shows an example of this form. FIG. 5B is a cross-sectional view of the separation container 2 with the inner container 11 disposed inside the outer container 20. As shown in FIG. 5B, the inner diameter of the projection 200 is greater than that of the opening 113 of the inner container 11. The third form is, for example, a form in which the inner diameter of the projection 200 is less than that of the opening 113 of the inner container 11. FIG. 5C shows an example of this form. FIG. 5C is a cross-sectional view of the separation container 2 with the inner container 11 disposed inside the outer container 20. As shown in FIG. 5C, the inner diameter of the projection 200 is less than that of the opening 113 of the inner container 11.

In the case where the separation subject is separated from the sample and settled by centrifugation, the first form and the second form shown in FIGS. 5A and 5B, respectively are preferable, for example. According to these forms, a flow path having no convex portion interrupting the movement of a liquid when the liquid moves from the inner container 11 to the storage portion of the outer container 20 can be configured between the inner container 11 and the outer container 20, for example. Therefore, a physical load on a target separation subject, caused by contact with the convex portion when the target separation subject moves from the inner container to the storage portion of the outer container can be reduced. In the case where the separation subject is, for example, sperms, the reduction in survival rate of the sperms can be suppressed by the reduction in the physical load.

In the case where the separation subject is sperms, and sperms which are superior in motility are recovered through causing the sperms to swim up from the storage portion, the first form and the third form shown in FIGS. 5A and 5C, respectively are preferable, for example. According to these forms, a flow path having no convex portion which interrupts sperms swimming up when the sperms move from the storage portion 103 of the outer container 20 to the inner container 11 can be configured between the storage portion 103 and the inner container 11, for example. Thus, sperms that have swum up can be led efficiently to the inner container 11, for example.

In the separation container 2 according to the present embodiment, the inner container 11 is disposed inside the outer container 20 as in Embodiment 1. At that time, the end face of the lower opening 113 of the inner container 11 is in contact with the inner peripheral surface of the outer container 20, i.e., the end face on the upper side of the projection 200. The separation container 2 according to the present embodiment can be used in the same manner as in Embodiment 1.

### Embodiment 3

A separation container according to the present embodiment shows an example of a form in which the volume of a storage portion inside an outer container can be changed.

### (1) Embodiment 3-1

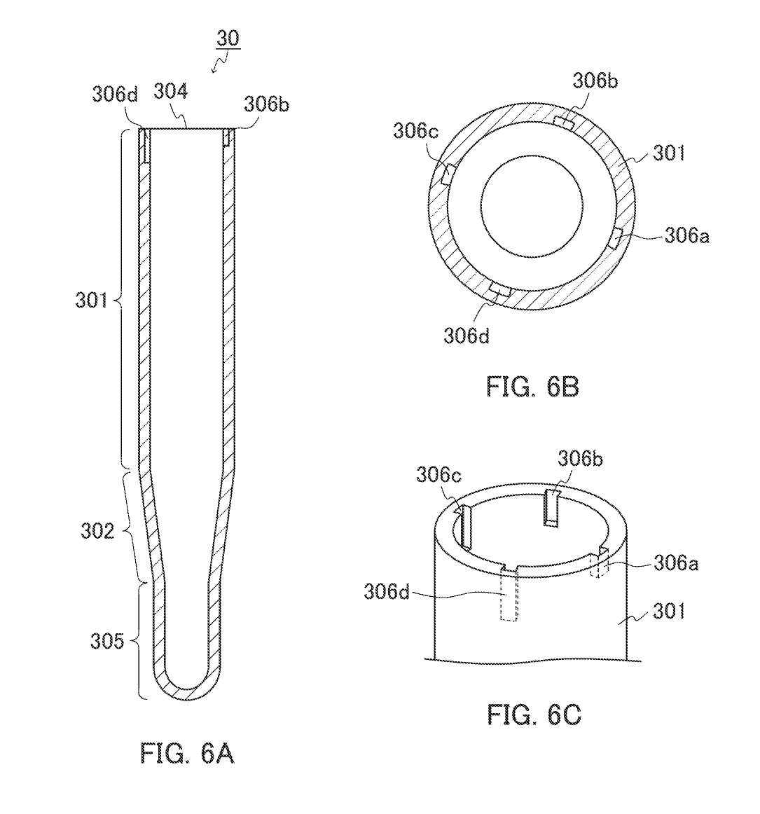

FIGS. 6A to 6C, 7A to 7B, and 8A to 8B each shows an outer container or an inner container configuring the separation container according to the present embodiment (a lid is not shown).

FIGS. 6A to 6C are schematic views of the outer container. FIG. 6A is a cross-sectional view of the outer container. FIG. 6B is a top plan view of the outer container. FIG. 6C is a top perspective view of the outer container. As shown in FIG. 6A, an outer container 30 has a bottomed tubular shape having an opening 304 at the upper end thereof and includes: a main body portion 301; a tapered portion 302; and a tip portion 305. As shown in FIGS. 6A to 6C, four grooves (concave portions) 306a, 306b, 306c, and 306d for engagement are formed on the inner peripheral surface in an upper portion of the main body portion 301. The grooves 306a, 306b, 306c, and 306d with different lengths are formed from the end portion on the opening 304 side of the main body portion 301 toward the axial direction. In FIGS. 6A to 6C, the lengths (depths) of the grooves are set so as to be longer in order from the groove 306a to the groove 306d. The shape of each of the grooves is not particularly limited and can be, for example, a V shape or the like other than rectangular shown in FIGS. 6A to 6C, for example.

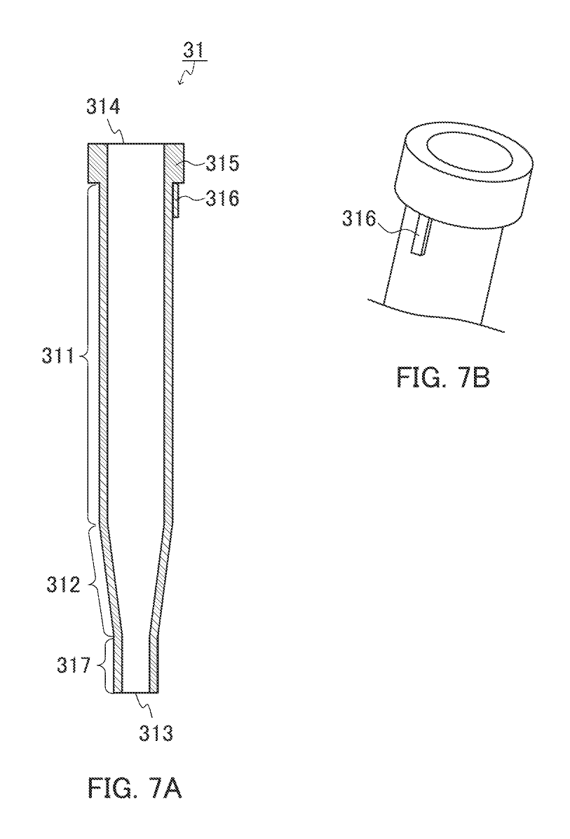

FIGS. 7A and 7B are schematic views of an inner container. FIG. 7A is a cross-sectional view, and FIG. 7B is a top perspective view of the inner container. As shown in FIGS. 7A and 7B, the inner container 31 has an opening 314 at the upper end thereof and an opening 313 at the lower end thereof and includes: a main body portion 311; a tapered portion 312; and a tip portion 317. The outer peripheral surface in an upper portion of the main body portion 311 of the inner container 31 has a circumferential projection 315, which is a grip portion of the inner container 31 as in Embodiment 1. A projection (convex portion) 316 for engagement further is formed on the outer peripheral surface of the main body portion 311 of the inner container 31, i.e., in a lower portion of the grip portion 315. The shape of the projection 316 is not particularly limited and preferably corresponds to the shape of the groove of the outer container 30. The shape can be, for example, a V shape other than rectangular as shown in FIGS. 7A and 7B, for example.

In the separation container according to the present embodiment, the projection 316 for engagement of the inner container 31 is inserted into any of the grooves 306a, 306b, 306c, and 306d for engagement of the outer container 30 when the inner container 31 is disposed inside the outer container 30, whereby the outer container 30 and the inner container 31 are engaged with each other. It is preferred that the projection 316 for engagement of the inner container 31 is longer than the deepest groove 306d for engagement. As mentioned above, the lengths of the grooves 306a, 306b, 306c, and 306d for engagement of the outer container are different from one another. Therefore, the position of the inner container 31 disposed inside the outer container 30 can be adjusted according to the groove for engagement into which the projection 316 for engagement is inserted into.

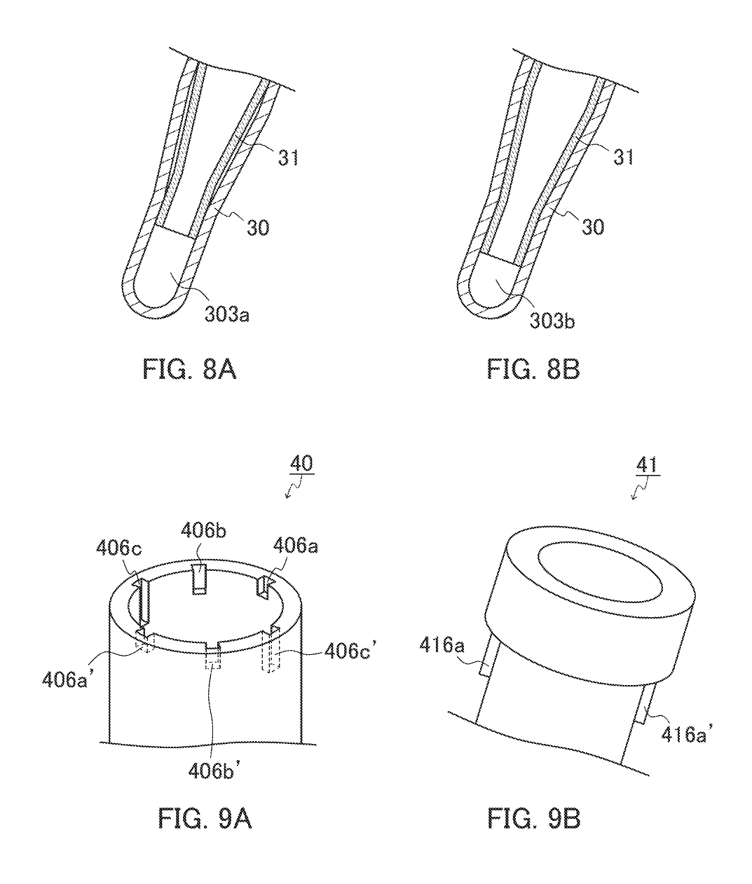

Specifically, the adjustment is described with reference to the schematic views of FIGS. 8A and 8B. FIGS. 8A and 8B are cross-sectional views showing the state where the inner container 31 is disposed inside the outer container 30. FIG. 8A shows the state where the projection 316 for engagement of the inner container 31 is inserted into the groove 306a for engagement of the outer container 30. FIG. 8B shows the state where the projection 316 for engagement of the inner container 31 is inserted into the groove 306d for engagement of the outer container 30. As shown in FIGS. 8A and 8B, when the projection 316 is inserted into the groove, the inner container 31 is inserted relatively shallowly into the outer container 30 when the length of the groove is short (FIG. 8A), and the inner container 31 is inserted relatively deeply into the outer container 30 when the length of the groove is long (FIG. 8B). Therefore, comparing the former and the latter, the volume of the storage portion 303a formed by disposing the inner container 31 inside the outer container 30 is relatively large in the former, and the volume of the storage portion 303b formed by disposing the inner container 31 inside the outer container 30 is relatively small in the latter. As described above, the depth of inserting the inner container 31 inside the outer container 30 can be adjusted according to the combination of the groove for engagement of the outer container 30 and the projection for engagement of the inner container 31. Thus, the volume of the storage portion formed by disposing the inner container 31 inside the outer container 30 can be adjusted easily.

Since the groove of the outer container 30 is engaged with the projection of the inner container as mentioned above, further insertion of the inner container 31 into the outer container 30 during centrifugal treatment or the like can be sufficiently avoided according to the separation container of the present embodiment, for example. Further, by the engagement, rotation of the inner container 31 inside the outer container 30 can be suppressed sufficiently.

In the present embodiment, the outer container 30 and the inner container 31 and the sizes thereof are not particularly limited and can be described with reference to the description of Embodiment 1, for example.

The size of the outer container 30 is not particularly limited, and examples thereof include the following conditions. The inner height of the tip portion 305 is, for example, from 4 to 20 mm, preferably from 5 to 15 mm. The width of each groove for engagement is, for example, from 0.5 to 4 mm, preferably from 1.5 to 2.5 mm. The length of each groove for engagement is, for example, from 1 to 20 mm, preferably from 2 to 5 mm and is preferably different. The number of the grooves for engagement is not at all limited, and the lower limit thereof is, for example, preferably 2, more preferably 3 or 4, and the upper limit thereof is, for example, preferably 10.

The size of the inner container 31 is not particularly limited, and examples thereof include the following conditions. The width of the projection for engagement is, for example, preferably less than that of each groove for engagement and is, for example, from 0.4 to 3.9 mm, preferably from 1 to 2 mm. The length of the projection for engagement is, for example, preferably identical to or greater than the depth of the longest groove for engagement and is, for example, from 2 to 21 mm, preferably from 3 to 6 mm.

The size of the storage portion with the inner container 31 disposed inside the outer container 30 is not particularly limited. It is preferred that the volume of the storage portion can be changed in stages from the lower limit to the upper limit according to the above-mentioned combination of the groove for engagement and the projection for engagement, for example. The lower limit is, for example, from 0.05 to 0.1 ml, and the upper limit is, for example, from 0.6 to 1.0 ml.

### (2) Embodiment 3-2

In the present embodiment, the number of projections for engagement in the inner container is not particularly limited. The number of projections for engagement may be, for example, 1 or more and is, for example, from 1 to 4, preferably from 1 to 3, more preferably from 1 or 2. By providing the inner container with a plurality of projections for engagement, the stability of the inner container in the outer container can be increased further, for example.

When the number of projections for engagement is set to two, it is preferred that the outer peripheral surface of the inner container has a pair of projections for engagement (a set of projections) at the respective positions at which the projections face each other, for example. Further it is preferred that the inner peripheral surface of the outer container 30 has a plurality of pairs of grooves for engagement (a plurality of sets of grooves) at the respective positions at which the grooves of each pair face each other so that each set of grooves corresponds to the set of projections, for example.

FIG. 9A shows an example of an outer container in the present embodiment. FIG. 9B shows an example of an inner container in the present embodiment. FIG. 9A is a perspective view showing an upper portion of the outer container. FIG. 9B is a perspective view showing an upper portion of the inner container. As shown in FIG. 9A, six grooves (concave portions) 406a, 406b, 406c, 406a′, 406b′, and 406c′ for engagement are formed on the inner peripheral surface of the outer container 40. The grooves 406a, 406b, and 406c are formed at the respective positions facing the grooves 406a′, 406b′, and 406c′. The lengths of the grooves 406a, 406b, and 406c are the same as the respective lengths of the grooves 406a′, 406b′, and 406c′, and the lengths are set so as to be longer in this order. As shown in FIG. 9B, two projections (convex portions) 416a and 416a′ for engagement with the same length are formed on the outer peripheral surface of the inner container 41 so as to face each other.

When the inner container 41 is disposed in the outer container 40, the projections 416a and 416a′ of the inner container 41 may be inserted into the grooves 406a and 406a′, the grooves 406b and 406b′, or the grooves 406c and 406c′, of the outer container 40, respectively. The volume of a storage portion formed by disposing the inner container 41 in the outer container 40 goes from small to large in the order of the grooves 406a and 406a′, the grooves 406b and 406b′, and the grooves 406c and 406c′.

### (3) Embodiment 3-3

The present embodiment shows another example of the shape of the groove for engagement of the outer container.

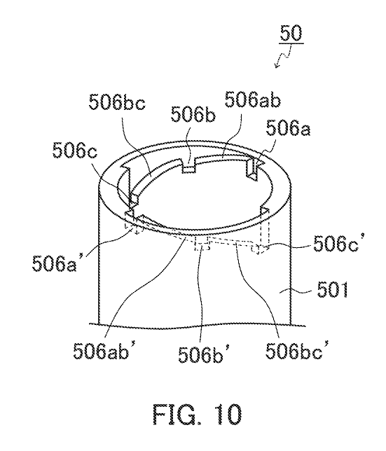

FIG. 10 shows another example of the outer container. FIG. 10 is a top perspective view of the outer container. As shown in FIG. 10, the outer container 50 has a bottomed tubular shape having an opening at the upper end thereof and includes: a main body portion 501, a tapered portion, and a tip portion. As shown in FIG. 10, six grooves (concave portions) 506a, 506b, 506c, 506a′, 506b′, and 506c′ for engagement are formed on the inner peripheral surface in an upper portion of the main body portion 501. Guiding portions for guiding the tip of the projection for engagement of the inner container to a desired groove when the inner container is inserted into the outer container 50 are further formed on the inner peripheral surface of the outer container 50. Specifically, a guiding portion 506ab is provided between the grooves 506a and 506b, and a guiding portion 506bc is provided between the grooves 506b and 506c. It is preferred that each of the guiding portions 506ab and 506bc has a shape sloping toward a deeper groove. Similarly, guiding portions 506ab′ and 506bc′ are provided with respect to the grooves 506a′, 506b′, and 506c′ corresponding to the grooves 506a, 506b, and 506c, respectively.

### Embodiment 4

A separation container according to the present embodiment shows an example of a form of preventing the fluid amount in the storage portion of the outer container from changing after taking the inner container out from the outer container.

In the case where an inner container is disposed inside an outer container after pouring a centrifugal treatment solution into the outer container, if a space is generated between the outer container and the inner container in the portion above the tip of the inner container, the centrifugal treatment solution may enter the space, for example. In such a case, when the inner container is taken out from the outer container after centrifugal treatment, the centrifugal treatment solution that has entered the space may run down the inner peripheral surface of the outer container and enter the storage portion of the outer container. If the centrifugal treatment solution enters the storage portion, recovered sperms may be diluted, resulting in a reduction in concentration thereof, for example. Thus the separation container according to the present embodiment also shows an example of a form of sufficiently preventing the fluid amount in the storage portion from changing by a contamination of the storage portion with the centrifugal treatment solution.

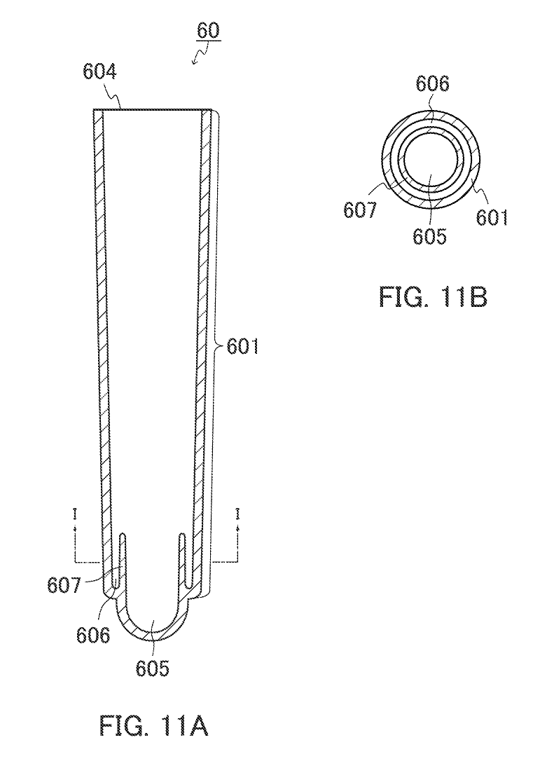

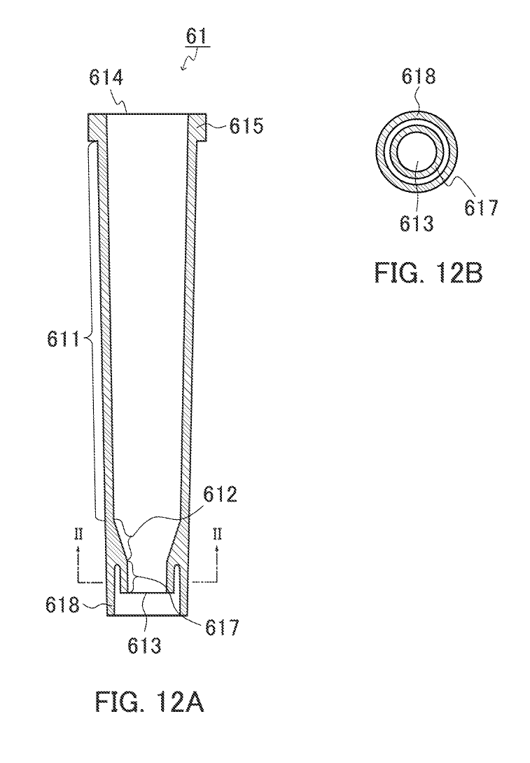

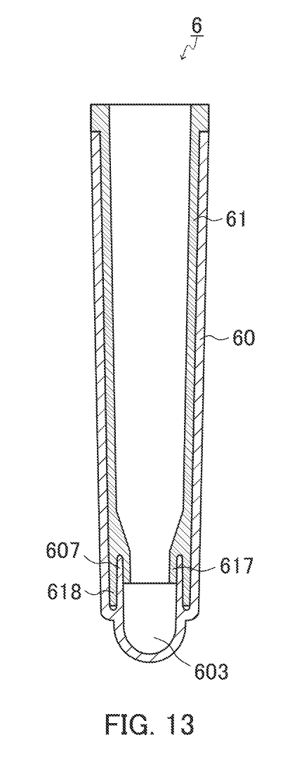

FIGS. 11A to 11B, 12A to 12B, and 13 show a separation container according to the present embodiment. FIGS. 11A to 11B are cross-sectional views of an outer container. FIG. 11A is a cross-sectional view of the outer container in the axial direction. FIG. 11B is a cross-sectional view taken along the line I-I of the tip of the outer container shown in FIG. 11A. FIGS. 12A to 12B are cross-sectional views of an inner container. FIG. 12A is a cross-sectional view of the inner container in the axial direction. FIG. 12B is a cross-sectional view taken along the line II-II of the tip of the inner container shown in FIG. 12A. FIG. 13 is a cross-sectional view of a separation container including the outer container and the inner container.

As shown in FIG. 11A, an outer container 60 has a bottomed tubular shape having an opening 604 at the upper end thereof and includes: a main body portion 601; a tip portion 605; and a groove 606. The tip portion 605 is cylindrical, and the circumferential groove 606 is formed by a circumferential side wall 607 and a side wall of the main body portion 601. Specifically, as shown in FIG. 11B, the groove 606 is concentrically formed around the cylindrical tip portion 605 with the side wall 607 as a partition.

As shown in FIG. 12A, an inner container 61 has an opening 614 at the upper end thereof and an opening 613 at the lower end thereof and includes: a main body portion 611; a tapered portion 612; and a tip portion 617. Further, a circumferential projection 618 is formed around the tip portion 617. Specifically, as shown in FIG. 12B, the circumferential projection 618 is formed around the cylindrical tip portion 617.

Then, by disposing the inner container 61 in the outer container 60, a separation container 6 is obtained. As shown in FIG. 13, in the separation container 6, the tip portion 617 of the inner container 61 is inserted into the tip portion 605 of the outer container 60, so that a storage portion 603 is formed in the tip portion 605 of the outer container 60. Further, the projection 618 of the inner container 61 is inserted into the groove 606 of the outer container 60.

According to such a separation container 6, for example, even when the inner container 61 is taken out from the outer container 60 after centrifugation, any centrifugal treatment solution running down the inner wall of the outer container 60 is supplied to the groove 606 of the outer container 60, resulting in preventing the centrifugal treatment solution from being supplied to the tip portion 605. Therefore, it is possible to sufficiently prevent the fluid amount in the storage portion 603 from changing as mentioned above. Furthermore, the projection 618 of the inner container 61 is being inserted into the groove 606 of the outer container 60 during centrifugation. Therefore, it is also possible to prevent the centrifugal treatment solution from being supplied to the groove 606 before the inner container 61 is taken out from the outer container 60. It is also possible to lead the centrifugal treatment solution running down to the groove 606 when the inner container 61 is taken out with certainty.

### Embodiment 5

The separation container according to the present embodiment shows an example of a form of preventing a contamination of an outer container with a liquid inside an inner container when the inner container is taken out from the outer container.

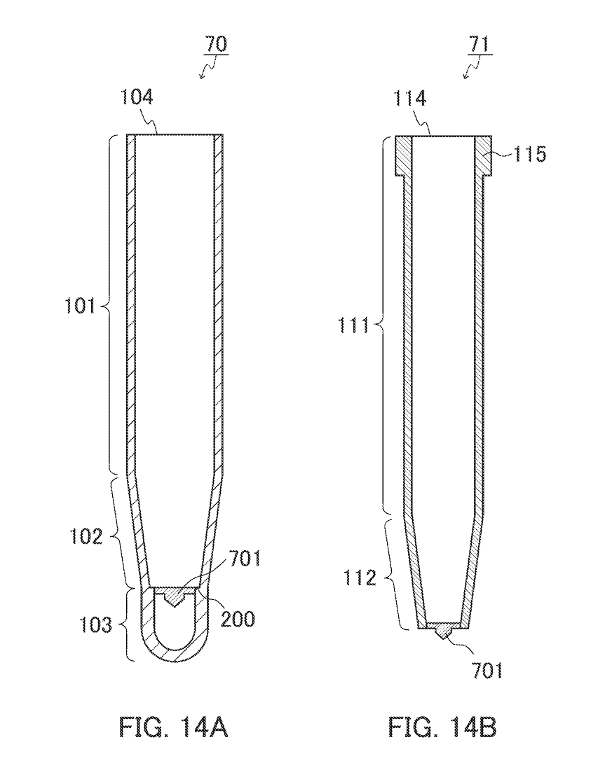

FIG. 14A shows an outer container configuring a separation container as a form of the separation container according to the present embodiment. FIG. 14A is a cross-sectional view of the outer container. The separation container according to the present embodiment can be used by combining the outer container of FIG. 14A and the inner container of FIG. 3B, for example. In FIG. 14A, parts identical to those in FIGS. 3A to 3C are denoted by the identical reference numerals.

As shown in FIG. 14A, an outer container 70 is in a form in which the outer container of FIG. 3A further includes a one-way valve 701 at the opening on the upper side of the storage portion 103. The one-way valve 701 allows a liquid to pass downward therethrough by the pressure change caused by centrifugation or the like. Therefore, only while the separation container obtained by disposing the inner container 11 of FIG. 3B inside the outer container 70 is subjected to centrifugation, is a liquid supplied from the inner container 11 to the storage portion 103 of the outer container 70 via the one-way valve 701. Then, even if a liquid is dropped down from the opening 113 on the lower side of the inner container 11 after the centrifugation, contamination of the storage portion 103 of the outer container 70 with the liquid via the one-way valve 701 can be prevented, for example. Furthermore, for example, when liquid is dropped down from the inner container 11, the liquid in an upper portion of the one-way valve 701 can be removed easily by a dropper or the like. Therefore, a recovered liquid being in the storage portion 103 can be collected thereafter.

FIG. 14B shows an inner container configuring a separation container as another form of the separation container according to the present embodiment. FIG. 14B is a cross-sectional view of the inner container. The separation container according to the present embodiment can be used by combining the outer container of FIG. 3A and the inner container of FIG. 14B, for example. In FIG. 14B, parts identical to those in FIGS. 3A to 3C are denoted by the identical reference numerals.

As shown in FIG. 14B, an inner container 71 is in a form in which the inner container of FIG. 3B further includes a one-way valve 701 at the opening 113 of the tip. In this case, only while the separation container obtained by disposing the inner container 71 inside the outer container 20 of FIG. 3A is subjected to centrifugation, is a liquid supplied from the inner container 71 to the storage portion 103 of the outer container 20 via the one-way valve 701. Even when the inner container 71 is taken out from the outer container 20 after the centrifugation, the one-way valve 701 is attached. Thus, the liquid can be prevented from leaking out from the opening 113 of the inner container 71.

As described above, providing the outer container or the inner container with an one-way valve can bring about further improvement in separation accuracy, for example.

The type of the one-way valve is not at all limited and can be, for example, a duckbill-type or a umbrella-type. The former is preferable.

### Embodiment 6

A separation container according to the present embodiment shows an example of a form of reducing physical damage caused by load-bearing during centrifugation.

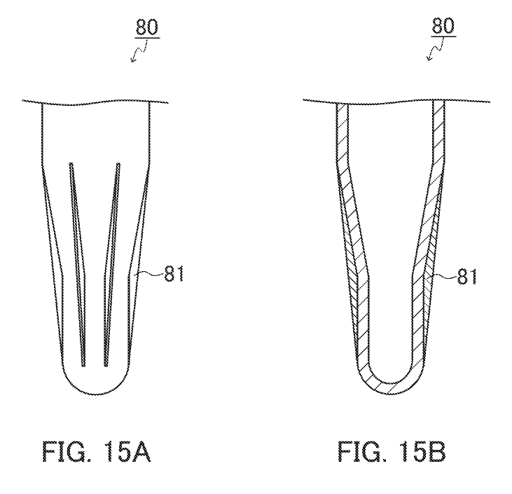

FIGS. 15A and 15B show an outer container configuring the separation container according to the present embodiment. In FIGS. 15A and 15B, FIG. 15A is a plan view of the tip portion of the outer container, and FIG. 15B is a cross-sectional view of the outer container. As shown in FIG. 15A, the outer container 80 is in a form in which the outer container of FIG. 6A further includes a rib 81 on the outer peripheral surface at the tip. For example, as mentioned above, the volume of the storage portion of the outer container preferably is small. Therefore, as shown in FIG. 6A, the tip portion of the outer container can be, for example, in a form in which the inner diameter and the outer diameter of the tip portion are smaller than those of the main body portion. Thus, disposing a rib on the outer peripheral surface of the thin tip portion of the outer container can bring about a reduction in physical damage caused by load-bearing during centrifugation.

Conditions of the rib, such as the size, the number, and the shape are not particularly limited. The number of ribs is not particularly limited and is, for example, preferably two or more. It is preferred that the ribs are disposed radially on the outer peripheral surface at equal distances.

### Embodiment 7

The present embodiment shows an example of the state of contact between the lower end of an inner container and an outer container.

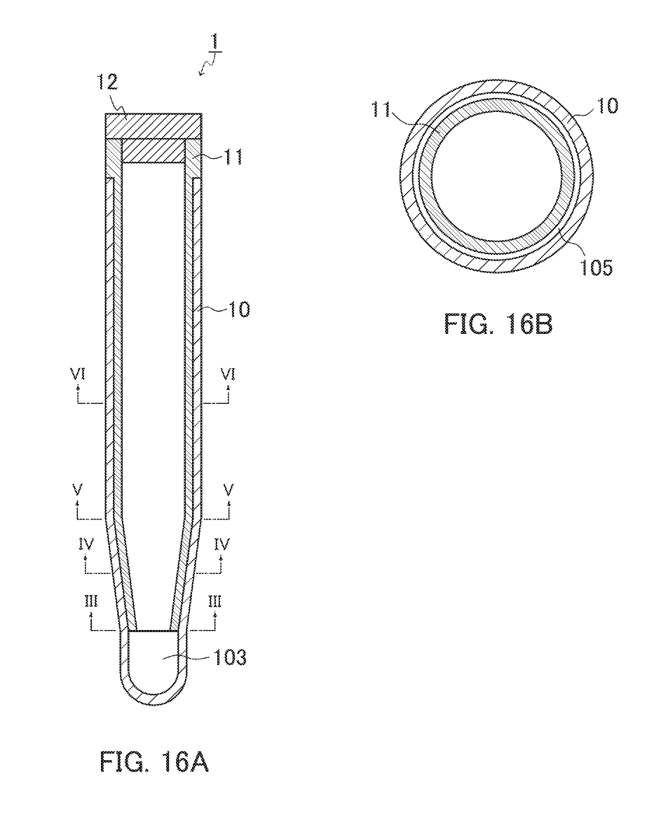

In the separation container, the outer peripheral surface of the outer container may not be in contact with the inner peripheral surface of the outer container, for example. Cross-sectional views of FIGS. 16A and 16B show an example of the separation container being in this form. FIG. 16A is a cross-sectional view of a separation container, and FIG. 16B is a cross-sectional view taken along the line of FIG. 16A.

As shown in FIG. 16B, the outer peripheral surface of an inner container 11 may not be in contact with the inner peripheral surface of an outer container 10. In the case of non-contact, a space 105 may be present between the inner container 11 and the outer container 10, for example. A distance between the outer peripheral surface of the inner container 11 and the inner peripheral surface of the outer container 10 (the length of the space 105) along the direction perpendicular to the axis is, for example, as mentioned above, preferably 200 μm or less, more preferably 100 μm or less, yet more preferably 50 μm less.

The inner container 11 and the outer container 10 may not be in contact with each other also on cross sections taken along the line IV-IV, the line V-V, and/or the line VI-VI of FIG. 16A as in FIG. 16B.

### Embodiment 8

The present embodiment shows examples of the state of contact between the lower end of an inner container and an outer container.

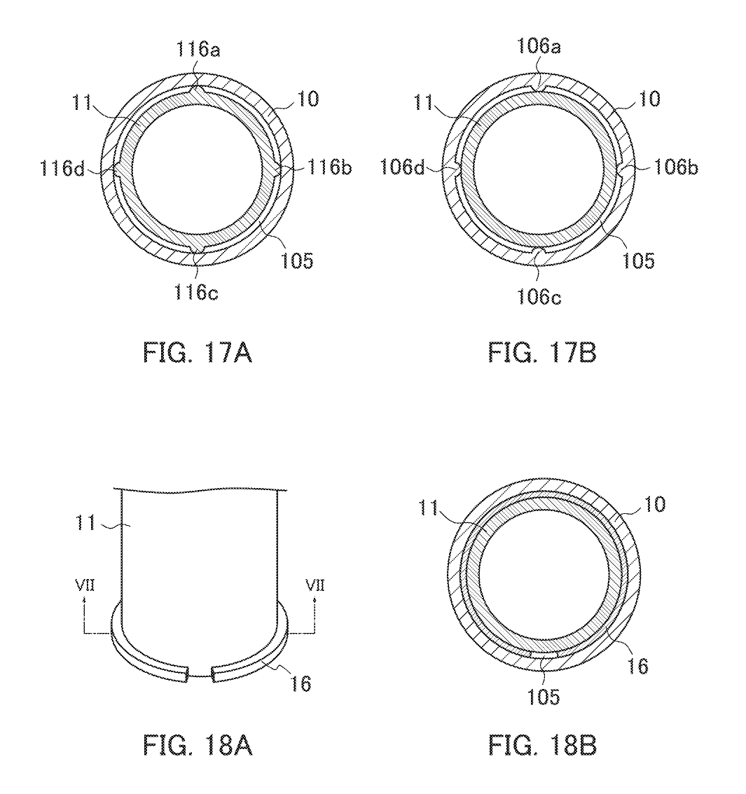

In the separation container, the outer peripheral surface of the inner container may partially be in contact with the inner peripheral surface of the outer container, for example. Cross-sectional views of FIGS. 17A and 17B show examples of the separation container being in this form. FIGS. 17A and 17B are cross-sectional views taken along the line of the separation container of FIG. 16A.

As shown in FIG. 17A, the outer peripheral surface of an inner container 11 has projections (116a, 116b, 116c, and 116d), and these projections are in contact with the inner peripheral surface of an outer container 10. As shown in FIG. 17B, the inner peripheral surface of an outer container 10 has projections (106a, 106b, 106c, and 106d), and these projections are in contact with the outer peripheral surface of an inner container 11.

Next, FIGS. 18A and 18B show another example. FIG. 18A is a perspective view schematically showing the tip portion of the inner container. FIG. 18B is a cross-sectional view taken along the line III-III of the separation container of FIG. 16A relating to the separation container including the inner container of FIG. 18A.

As shown in FIG. 18A, the outer peripheral surface of the tip of the inner container 11 includes a projected rib 16. As shown in FIG. 18B, in the separation container, the inner container 11 and the outer container 10 are in contact with each other via the rib 16. The rib 16 is not a fully circumferential rib and includes a deleted portion, so that a space 105 is formed in this deleted portion. In the present embodiment, the tip of the inner container 11 is provided with the rib 16. The present invention, however, is not limited thereto, and the rib may be formed on the outer peripheral surface in the portion above the tip, for example.

In the present embodiment, the outer peripheral surface of the inner container 11 includes a rib 16. The present invention, however, is not limited by this, and the rib 16 may be formed on the inner peripheral surface of the outer container 10.

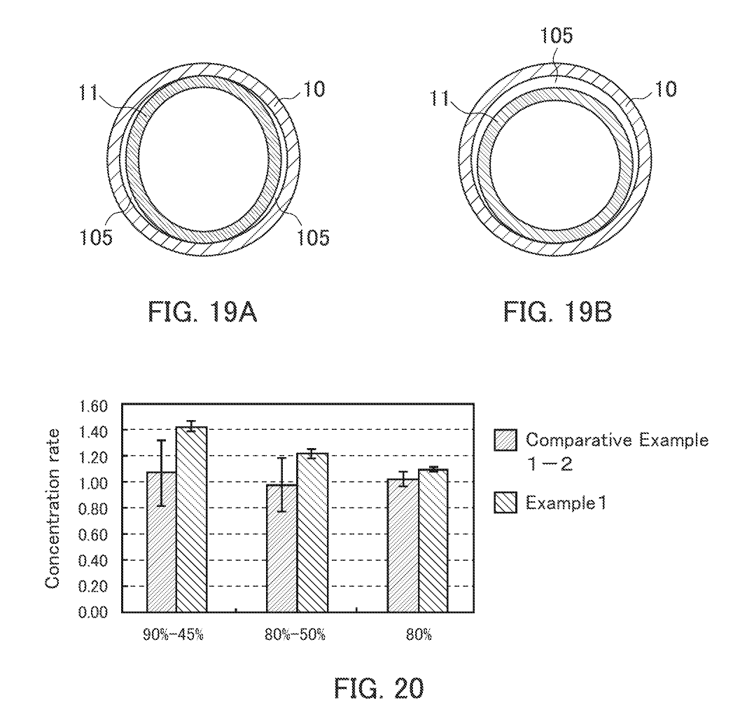

FIGS. 19A and 19B show yet other examples. FIGS. 19A and 19B are cross-sectional views taken along the line of the separation container of FIG. 16A.

As shown in FIG. 19A, an inner container 11 is oval tubular, and the outer peripheral surface thereof may be in contact with the inner peripheral surface of an outer container 10 at longitudinal both ends in the perpendicular direction to the axis. In FIG. 19B, an inner container 11 is disposed non-coaxially in an outer container 10. The inner peripheral surface of the outer container 10 may be in contact with a part of the outer peripheral surface and may not be in contact with a part of the outer peripheral surface, facing the part in contact.

### EXAMPLES

Next, the examples of the present invention are described. The present invention, however, is not limited thereby.

### Example 1

In the present example, a precipitate fraction containing sperms was recovered through centrifugation using a separation container according to the present invention. Then, the recovery rate of living sperms was determined.

A separation container shown in FIGS. 3A to 3C and 4 was produced. The sizes thereof are as follows.

Outer container 20

Total volume: 9.85 ml

Inner height of the entire outer container: 85 mm

Height of main body portion 101: 60 mm

Height of tapered portion 102: 14 mm

Height of storage portion 103: 12 mm

Diameter of opening 104: 14.5 mm

Inner diameter at the upper end of tapered portion 102: 12.41 mm

Inner diameter at the lower end of tapered portion 102: 7.2 mm Inner diameter of projection 200: 6.2 mm

Volume of storage portion 103: 0.3 ml

Inner height of storage portion 103: 11 mm

Inner container 11

Total volume: 7.7 ml

Height of the entire inner container: 84 mm

Height of main body portion 111: 68 mm

Height of tapered portion 112: 16 mm

Inner diameter of upper opening 114: 12.4 mm

Outer diameter of upper opening 114: 16.3 mm

Outer diameter at upper end of tapered portion 112: 12.2 mm

Outer diameter of lower opening 113: 7 mm

Inner diameter of lower opening 113: 5 mm

### Lid 12

Outer diameter of grip portion 121: 16.47 mm

Outer diameter of insertion portion 122: 12.47 mm

Height of insertion portion 122: 5 mm

An inner container 11 was disposed inside an outer container 20. Then, Percoll (trade name: Percoll, produced by GE Healthcare Japan Corporation) was supplied to the inner container 11. Specifically, first, 1.5 ml of 90% Percoll was supplied, and then 1.5 ml of 45% Percoll was layered thereon. 0.28 ml of a semen was further layered on the Percoll. A lid 12 was attached over an opening 114 of the inner container 11. Then, centrifugation was performed at 700G (700×9.80665 m/s²) for 30 minutes. Thereafter, with the lid 12 attached, the inner container 11 was taken out from the outer container 20. Then, living sperms, dead cells, and impurities in a Percoll solution (total amount: 300 μL) in the outer container 20 were measured by flow cytometry, and the proportions (%) thereof were determined.

### Comparative Example 1

In the present example, a precipitate fraction containing sperms was recovered from 0.28 ml of the same semen as in Example 1 through centrifugation using a conventional separation container. Then the recovery rate of living sperms was determined.

### Comparative Example 1-1

In the present example, a 15 ml-volume centrifuge tube (trade name: 15 ml centrifuge tube, produced by Corning Incorporated) as a separation container, a nozzle (trade name: ART capillar, produced by Nipro Corporation), and a syringe (trade name: JMS syringe, produced by JMS Co., Ltd.) capable of being set to the nozzle were used. The nozzle was disposed inside the centrifuge tube so that the tip of the nozzle was located at the bottom of the centrifuge tube. Then, Percoll was supplied to the centrifuge tube. Specifically, first, 1.5 ml of 90% Percoll was supplied, and 1.5 ml of 45% Percoll was layered thereon. 0.28 ml of semen was further layered on the Percoll. Then, a lid was put on the centrifuge tube, which then was subjected to centrifugation in the same manner as in Example 1. Thereafter, the lid was taken out, and the syringe was set to the back end of the nozzle disposed in the centrifuge tube. Then 0.3 ml of a Percoll solution as a precipitate fraction containing sperms in the bottom of the centrifuge tube was aspirated through the nozzle. Then, in the same manner as in Example 1, living sperms, dead cells, and impurities in the recovered Percoll solution were measured, and the proportions (%) thereof were determined.

### Comparative Example 1-2

In the present example, a 15 ml-volume centrifuge tube (trade name: 15 ml centrifuge tube, produced by Corning Incorporated) as a separation container and a pipette were used. Percoll was supplied to the centrifuge tube. Specifically, first, 1.5 ml of 90% Percoll was supplied, and then 1.5 ml of 45% Percoll was layered thereon. 0.28 ml of semen was further layered on the Percoll. Then, a lid was put on the centrifuge tube, which was then subjected to centrifugation in the same manner as in Example 1. Thereafter, the lid was taken out, and the pipette was inserted into the centrifuge tube. Then, 0.3 ml of the Percoll solution in the bottom of the centrifuge tube was aspirated as a precipitate fraction containing sperms. Then, in the same manner as in Example 1, living sperms, dead cells, and impurities in the Percoll solution recovered as described above were measured, and the proportions (%) thereof were determined.

Table 1 shows the results of these. As shown in Table 1, according to the present invention, living sperms with very low proportions of impurities could be recovered with high efficiency. Moreover, according to the separation container of the present example, a sample with high concentration of living sperms could be obtained from 300 μl of a semen, which is a very small amount through merely taking the inner container 11 out without pipetting.

TABLE 1

| | Ex. 1 | Comp. Ex. 1-1 | Comp. Ex. 1-2 |
|---|---|---|---|
| Living sperm | 84.4% | 64.2% | 67.5% |
| Dead cell | 3.4% | 4.7% | 3.6% |
| Impurity | 12.2% | 31.1% | 28.9% |
| Sample amount | 300 μL | 300 μL | 300 μL |

### Example 2

In the present example, a precipitate fraction containing sperms was recovered through centrifugation using a separation container according to the present invention, and repeatability of the recovery rates of living sperms was determined.

As separation containers, separation containers of Example 1 and Comparative Example 1-2 were used. Sperms in fresh swine semen were used. Then, living sperms were separated from the sperms by three experimenters who had not experienced a sperm separation using each separation container. The separation method was performed in the same manner as in Example 1 or Comparative Example 1-2 according to each separation container except that the conditions of the Percoll were changed as follows. The conditions of the Percoll include: (1) supplying 1.5 ml of 90% Percoll and thereafter layering 1.5 ml of 45% Percoll thereon; (2) supplying 1.5 ml of 80% Percoll and thereafter layering 1.5 ml of 50% Percoll thereon; and (3) supplying 3.0 ml of 80% Percoll.

After the separation, living sperms before centrifugation and living sperms in the Percoll solution (total amount of 300 ml) inside an outer container after centrifugation were measured by flow cytometry in the same manner as in Example 1. Then, the rate of the latter to the former was determined as the concentration rate assuming that the former was 1. Thereafter, the average value of the concentration rates from the three experimenters was calculated with respect to each condition.

FIG. 20 shows the results of these. In FIG. 20, the vertical axis indicates the average value of the concentration rates of living sperms. In FIG. 20, 90%-45% indicates the Percoll condition (1), 80%-50% indicates the Percoll condition (2), and 80% indicates the Percoll condition (3). In each Percoll condition, two bars indicate the result obtained using the separation container of Comparative Example 1-2 and the result obtained using the separation container of Example 1, starting from the left. As shown in FIG. 20, according to the separation container of Example 1, the highest concentration rate could be achieved under any Percoll condition. Moreover, according to the separation container of Example 1, a variation in result among experimenters was very small compared with the case using the separation container of Comparative Example 1-2. These results demonstrate that according to the separation container of the present invention, living sperms in the concentrated state can be recovered efficiently with high repeatability regardless of whether or not operators are skilled.

### Example 3

In the present example, sperms were recovered using a separation container according to the present invention, and the motility rate of the sperms were checked.

As separation containers, separation containers of Example 1, Comparative Example 1-1, and Comparative Example 1-2 were used. Then, five human semen samples were treated in the same manner as in Example 1, Comparative Example 1-1, or Comparative Example 1-2 according to each separation container.

After the separation, motility rate and rapid progressive motility rate of recovered sperms were calculated according to the WHO laboratory manual for the Examination and processing of human semen FIFTH EDITION (2010). Then, with respect to each separation container, an average value of five samples was determined. Table 2 shows the results of these. As shown in Table 2, the results with respect to sperms recovered using the separation container of Example 1 was superior compared with those with respect to sperms obtained using separation containers of Comparative Examples, and specifically, the result of the rapid progress motility rate was really superior. These results demonstrate that according to the separation container of Example 1, living sperms can be recovered without affecting sperms.

TABLE 2

| | Ex. 1 | Comp. Ex. 1-1 | Comp. Ex. 1-2 |
|---|---|---|---|
| Mobility rate (%) | 80.5 | 67.5 | 67.1 |
| Rapid forward motility rate (%) | 57.2 | 49.0 | 56.5 |

### INDUSTRIAL APPLICABILITY

According to the separation container of the present invention, a separation subject settled by centrifugation can be led to the storage portion of the outer container through a tip port at the lower end of the inner container, for example. Then, the inner container is made liquid-tight by attaching the lid thereover. Therefore, the separation subject can be recovered to the outer container by merely taking the inner container out from the outer container. Moreover, according to the separation container of the present invention, the storage portion can be designed in any size. Therefore, it is possible to set the fluid amount that remains inside the outer container after taking the inner container out from the outer container to any amount, i.e., a small amount. When the fluid amount is small, a sample with high concentration of the separation subject can be obtained. When Percoll or the like is used as a centrifugal treatment solution, the amount thereof to be used can be reduced, resulting in reduced cost thereof.

The invention of the present application is described above with reference to the embodiments. The invention of the present application, however, is not limited to the above-described embodiments. Various changes and modifications that may become apparent to those skilled in the art may be made in the configuration and specifics of the present invention without departing from the scope of the present invention.

This application claims priority from Japanese Patent Application No. 2010-250699 filed on Nov. 9, 2010. The entire disclosure of the Japanese Patent Application is incorporated herein by reference.

### EXPLANATION OF REFERENCE NUMERALS

1, 2, 6 separation container
10, 20, 30, 40, 50, 60, 70, 80 outer container
11, 31, 41, 61, 71 inner container
12 lid
101, 111, 301, 311, 501, 601, 611 main body portion
102, 112, 302, 312, 612 tapered portion
103, 303a, 303b, 603 storage portion
104, 113, 114, 304, 313, 314, 604, 613, 614 opening
121 grip portion
122 insertion portion
115, 200 projection
306a to 306d, 406a to 406c, 406a′ to 406c′, 506a to 506c, 506a′ to 506c′ groove
305, 317, 605, 617 tip portion
315, 316, 416a, 416a′ projection
506ab, 506bc, 506ab′, 506bc′ guiding portion
606 groove
607 side wall
618 projection
701 one-way valve
16, 81 rib
105 space
106a to 106d, 116a to 116d projection

1. A separation container for separating a separation subject from a sample, the separation container comprising:
an outer container;
an inner container; and
a lid, wherein
the outer container has a bottomed tubular shape with an upper end thereof open and a lower end thereof closed,
the inner container is tubular with upper and lower ends thereof open,
the inner container can be disposed inside the outer container with the up and down orientation of the inner container and the outer container aligned, and
with the inner container disposed inside the outer container, a region below the disposed inner container inside the outer container is a storage portion for a precipitate in the sample,
the lid is attachable over and detachable from an opening at the upper end of the inner container, and
the inner container is made liquid-tight by attaching the lid over the opening of the inner container.

2. The separation container according to claim 1, wherein
with the inner container disposed inside the outer container, at least one of an end face of a tip port and an outer peripheral surface of a tip at a lower end of the inner container is in contact with an inner peripheral surface of the outer container.

3. The separation container according to claim 2, wherein
the whole or a part of the end face of the tip port at the lower end of the inner container is in contact with the inner peripheral surface of the outer container.

4. The separation container according to claim 2, wherein
the whole or a part of the outer peripheral surface of the tip at the lower end of the inner container is in contact with the inner peripheral surface of the outer container.

5. The separation container according to claim 1, wherein
the inner peripheral surface at the upper end of the storage portion of the outer container comprises a circumferential projection, and
the end face of the tip port at the lower end of the inner container is in contact with the projection.

6. The separation container according to claim 1, wherein
the outer peripheral surface of the inner container comprises a tapered portion.

7. The separation container according to claim 6, wherein
the tapered outer peripheral surface of the inner container is in contact with the inner peripheral surface of the outer container.

8. The separation container according to claim 1, wherein either one of the inner peripheral surface of the outer container and the outer peripheral surface of the inner container comprises a projection, and the other comprises a groove capable of engaging with the projection.

9. The separation container according to claim 1, wherein
the outside of the storage portion of the outer container comprises a concentric groove,
the outside of the tip of the inner container comprises a concentric projection, and
the concentric projection of the inner container can be inserted into the concentric groove of the outer container when the inner container is disposed inside the outer container.

10. The separation container according to claim 1, for use in separation of a sperm from a sample.

11. A method of separating a separation subject from a sample, using the separation container according to claim 1, the method comprising the steps of:
(A1) disposing an inner container inside an outer container and adding a centrifugal treatment solution to the inner container and a storage portion of the outer container;
(B1) supplying a sample to the inner container after the step (A1);
(C1) subjecting the separation container to centrifugation after the step (B 1), whereby a precipitate in the sample is led to the storage portion of the outer container; and
(D1) taking the inner container out from the outer container after the step (C1) with the lid attached over the inner container.

12. The separation method according to claim 11, wherein
the step (A1) is either one of the steps of:
(A1-1) disposing an inner container inside an outer container and thereafter supplying a centrifugal treatment solution to the inner container, whereby the centrifugal treatment solution is added to the inner container and a storage portion of the outer container; and
(A1-2) supplying a centrifugal treatment solution to the outer container and thereafter disposing the inner container inside an outer container, whereby the centrifugal treatment solution is added to the inner container and a storage portion of the outer container.

13. The separation method according to claim 11, wherein
the centrifugal treatment solution is at least one selected from the group consisting of density gradient carriers, media, and buffer solutions.

14. The separation method according to claim 11, wherein
the centrifugal treatment solution is a density gradient carrier, and in the step (B1), the sample is layered on the density gradient carrier.

15. The separation method according to claim 11, wherein
the separation subject is sperm,
in the step (C1), the separation container is subjected to centrifugation, whereby a sperm in the sample is settled and led to the storage portion of the outer container, and
in the step (D1), the inner container is taken out from the outer container, and the sperm in the storage portion of the outer container is recovered.

16. The separation method according to claim 11, wherein
the separation subject is sperm,
in the step (C1), the separation container is subjected to centrifugation, whereby sperm in the sample is settled and led to the storage portion of the outer container, and
in the step (D1), the inner container is taken out from the outer container, and
the method further comprises the steps of:
(E1) after the step (D1), disposing another inner container in the outer container and adding a liquid in which a sperm can swim to the another inner container before or after the disposition; and
(F1) after the step (E1), recovering the sperm that has swum up from the storage portion of the outer container to the another inner container.

17. The separation method according to claim 16, wherein
in the step (F1), the another inner container is taken out from the outer container with the lid attached over the another inner container, and the sperm being in the another inner container is recovered.

18. The separation method according to claim 11, wherein
the sample includes semen.

19. A method of separating a separation subject from a sample, wherein
the separation subject is a sperm,
the separation container according to claim 1 is used, and
the method comprises the steps of:
(A2) supplying a sample to a storage portion of an outer container;
(B2) after the step (A2), disposing an inner container inside the outer container and adding a liquid in which a sperm can swim to the inner container before or after the disposition; and
(C2) after the step (B2), recovering the sperm that has swum up from the storage portion of the outer container to the inner container.

20. The separation method according to claim 19, wherein
in the step (C2), the inner container is taken out from the outer container with the lid attached over the inner container, and the sperm in the inner container is recovered.
